(19) United States
(12) Patent Application Publication
(10) Pub. No.: US 2009/0129887 A1
(43) Pub. Date: May 21, 2009

(54) SCREW KIT

(76) Inventor: Peter J.H. CHANG, Taipei (TW)

Correspondence Address: Joe McKinney Muncy, PO Box 1364, Fairfax, VA, 22038-1364, US

(21) Appl. No.: 11/942,594

(22) Filed: Nov. 19, 2007

(51) Int. Cl. F16B 23/00

(52) U.S. Cl. 411/402

(57) ABSTRACT

The present invention discloses a screw kit, which comprises: a screw element, a driving element, and an alignment element. The screw element has a screw end and a first coupling portion. The driving element has a driving end and a second coupling portion. The alignment element has a first sleeving section and a second sleeving section, which are respectively engageable with the first coupling portion and the second coupling portion. When the screw element and the driving element are simultaneously engaged with the alignment element, the deviation between the screw element and the driving element is eliminated, and the screw element and the driving element can be easily aligned to an identical axis. Thereby, the assembling and disassembling speeds of the screw element and the driving element are increased without influencing the theft-protection function thereof.

### FIELD OF THE INVENTION

The present invention relates to a screw kit, particularly to a tool kit for fastening automobile components.

### BACKGROUND OF THE INVENTION

Automobile manufacturers manufacture automobiles with different automobile wheel shafts, which respectively have screws or screw holes of different specifications. Each wheel rim needs holes to be passed through by nuts or screws so that nuts or screws can fasten the wheel rim to the wheel shaft. Refer to FIG. 1. Generally, automobile wheel shafts of different automobile designs or manufacturers respectively have screws or screw holes of different numbers, usually 4 or 8. A wheel rim manufacturer often designs a wheel rim 4 to have holes 41 adaptive to the wheel shafts of at least two styles of automobiles if the holes do not influence the strength of the wheel rim 4. In such a case, the diameter of the hole 41 should be reduced so that more holes 41 can be formed on the wheel rim 4. Thus, the traditional sleeve wrapping and applying force to the nuts or screws will be blocked outside the holes 41. Therefore, a screw element 1 having a screw end 12 and a first coupling portion 11 was developed. The screw end 12 has an outer thread 121, and the first coupling portion 11 has a socket 111 on the top thereof. At the same time, there is also a driving element 2 having a second coupling portion 21 and a driving end 22. The driving end 22 has at least one driving facet 221. The second coupling portion 21 has protrusions 211 to engage with the socket 111 so that the driving element 2 can apply force to the screw element 1. Thereby, the screw kit can apply to the abovementioned improved wheel rim 4. Further, varying the shape of the socket 111 and the protrusions 211 can have a theft-protection function. Such a design was disclosed in a R.O.C. patent No. 257732 “Automobile Screw Kit” and a R.O.C. patent application No. 096208736 “Theft-Protection Structure for Screw Kit” of the inventor of the present invention. Refer to FIG. 2. The abovementioned technology not only can apply to the improved wheel rim 4 but also has a theft-protection function. The abovementioned driving element 2 should be engageable with the abovementioned screw element 1 so that the driving element 2 can apply force to the screw element 1. Therefore, the driving element 2 cannot couple with the screw element 1 until the axis of the driving element 2 is aligned to coincide with the axis of the screw element 1 and the driving element 2 is rotated to a correct angle. However, there is often a gap between the hole 41 and the driving element 2. Thus, the axis of the driving element 2 is usually hard to be aligned to coincide with the axis of the screw element 1. Then, the abovementioned design may contrarily decrease the speed of assembling or disassembling the screw elements 1. Therefore, it is desirous to have an improved measure to increase the speed of assembling/disassembling the screw elements 1 to/from the wheel rim 4 through the holes 41, in addition to the theft-protection function.

### SUMMARY OF THE INVENTION

The object of the present invention is to provide an improved theft-protection screw kit, which has a theft-protection function, applies to the improved wheel rims, can increase the assembling and disassembling speeds and comprises: a screw element and a driving element.

The screw kit of the present invention is a tool kit for fastening automobile components and comprises: a screw element, a driving element and an alignment element. The screw element has a screw end and a first coupling portion, and the driving element has a driving end and a second coupling portion, and the second coupling portion can couple with the first coupling portion. The alignment element has a first sleeving section and a second sleeving section, which are respectively engageable with the first coupling portion and the second coupling portion. When the screw element and the driving element are simultaneously engaged with the alignment element, the deviation between the screw element and the driving element is eliminated, and the screw element and the driving element can be easily aligned to an identical axis. Thereby, the assembling and disassembling speeds of the screw element and the driving element are increased without influencing the theft-protection function thereof.

### BRIEF DESCRIPTION OF THE DRAWINGS

FIG. 1 is a diagram schematically showing an improved wheel rim.

FIG. 2 is a diagram schematically showing the deviation between the conventional screw element and the conventional driving element.

FIG. 3 is a perspective view of one embodiment of the present invention.

FIG. 4 is a sectional view of one embodiment of the present invention.

FIG. 5 is a diagram schematically showing one embodiment of the present invention.

FIG. 6 is a diagram schematically showing the assemblage of one embodiment of the present invention.

FIG. 7 is a diagram schematically showing another embodiment of the present invention.

FIG. 8A is a diagram schematically showing the alignment element of one embodiment of the present invention.

FIG. 8B is a diagram schematically showing the alignment element of another embodiment of the present invention.

FIG. 9 is a diagram schematically showing the application of the alignment element of another embodiment of the present invention.

FIG. 10 is another diagram schematically showing the application of the alignment element of another embodiment of the present invention.

FIG. 11 is a perspective view of further embodiment of the present invention.

FIG. 12 is a sectional view of further embodiment of the present invention.

FIG. 13 is a diagram schematically showing the assemblage of further embodiment of the present invention.

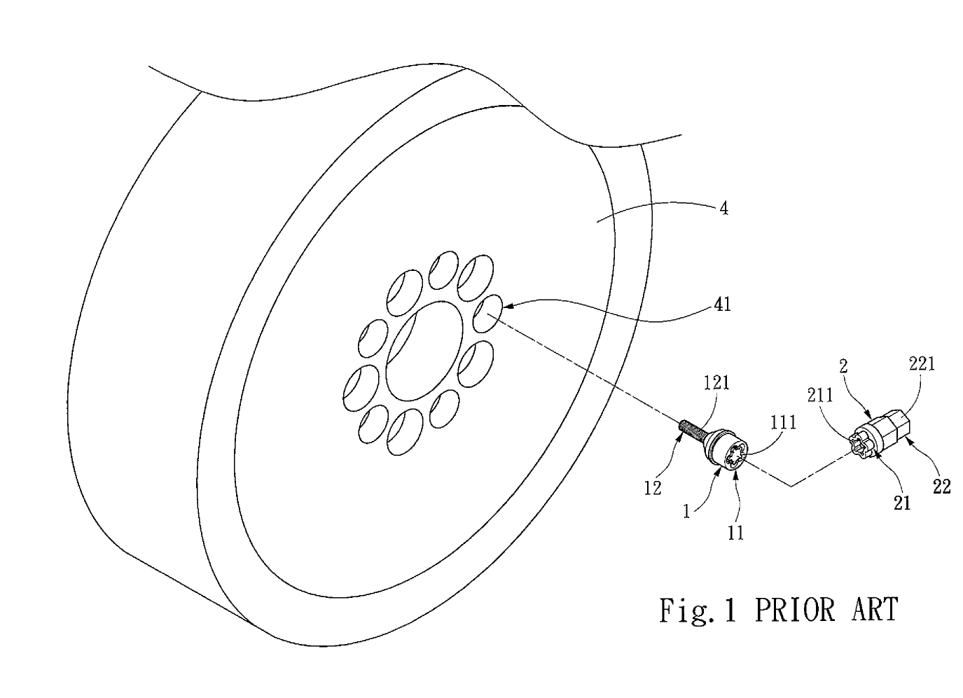

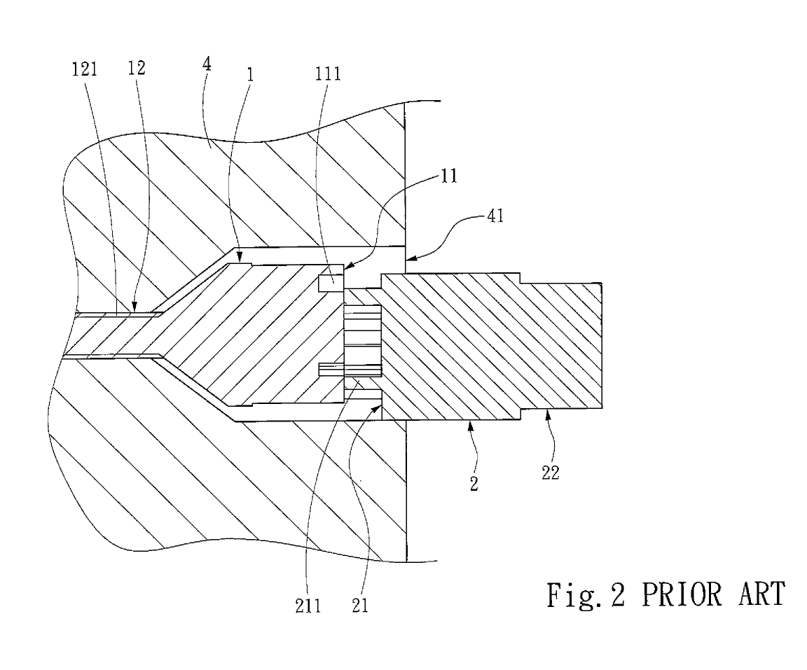

### DETAILED DESCRIPTION OF THE PREFERRED EMBODIMENTS

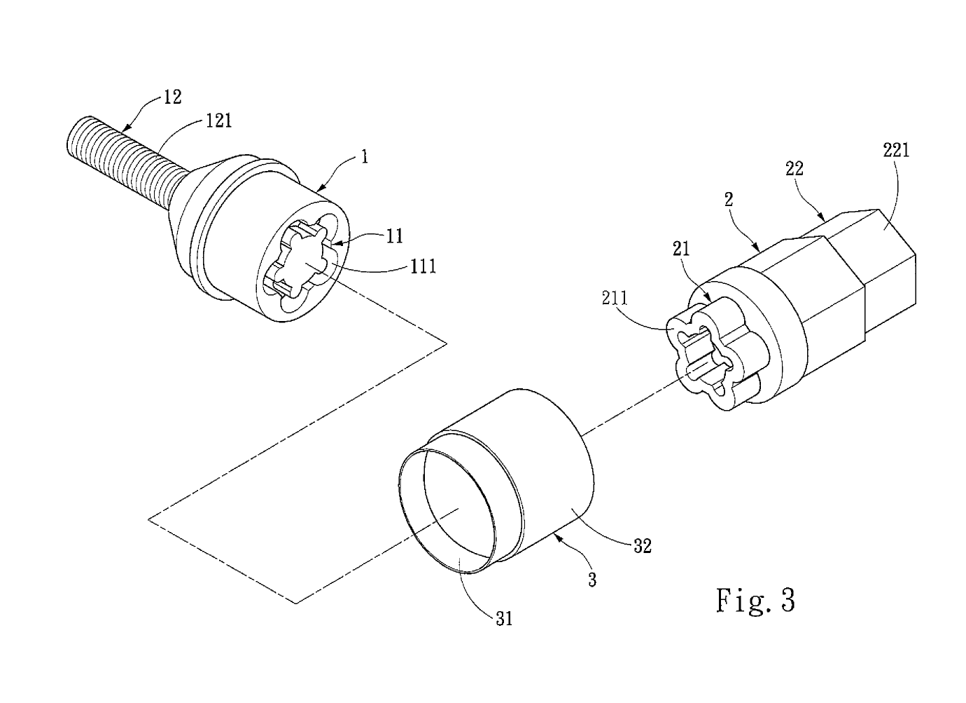

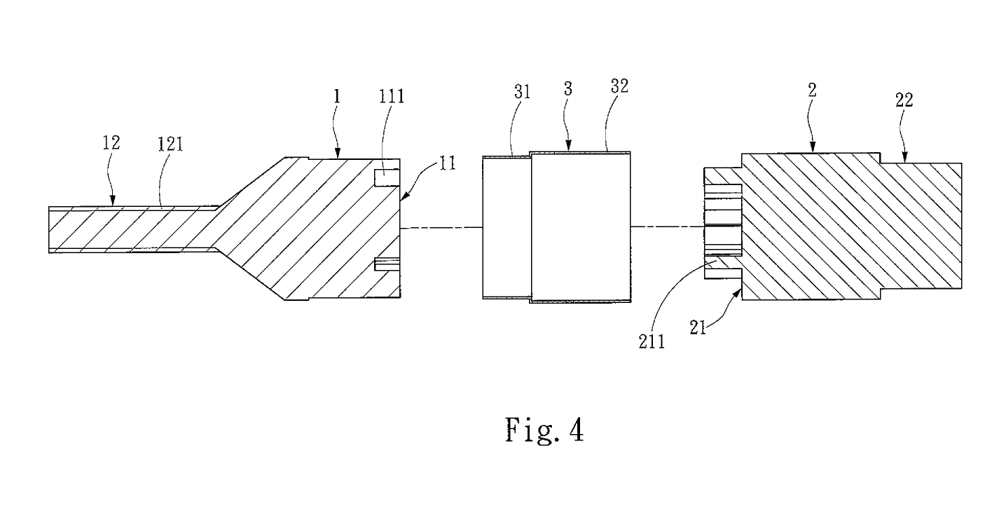

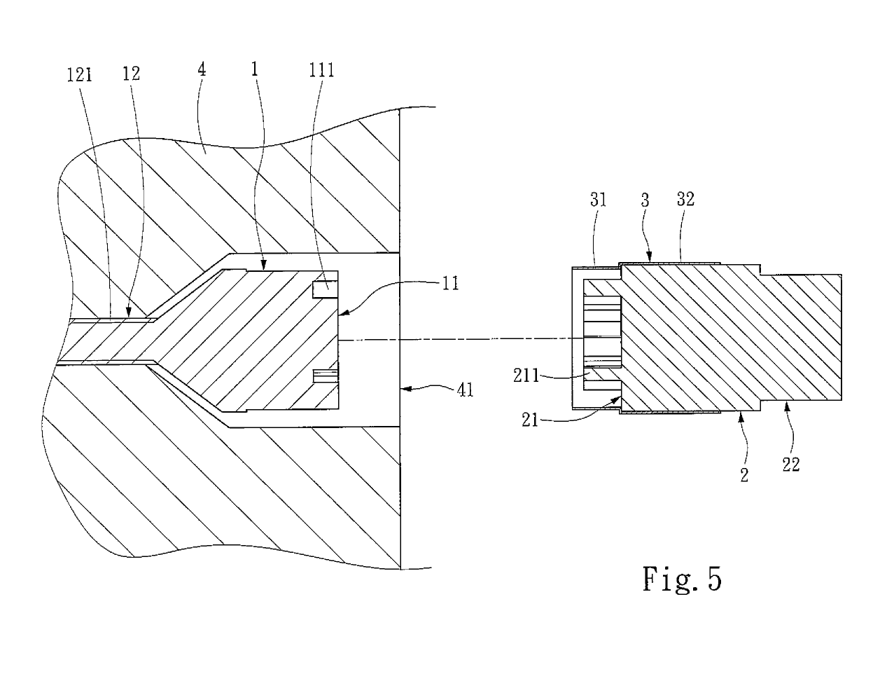

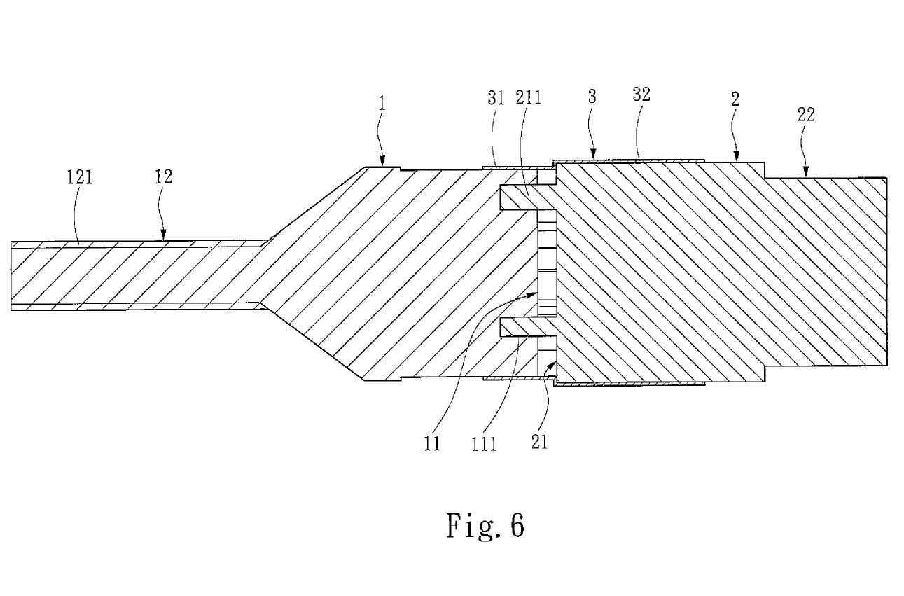

Refer to FIG. 3 and FIG. 4. The present invention is a screw kit, which comprises: a screw element 1, a driving element 2, and an alignment element 3. The screw element 1 has a screw end 12 and a first coupling portion 11; the screw end 12 is a pillar structure having an outer thread 121, which makes the screw element 1 function as a bolt. The driving element 2 has a driving end 22 and a second coupling portion 21; the second coupling portion 21 can couple with the first coupling portion 11, and the driving end 22 is a geometrical structure having at least one driving facet 221 where various types of sleeves or pneumatic tools can apply force. The first coupling portion 11 of the screw element 1 has a socket 111, and the second coupling portion 21 of the driving element 2 has protrusions 211 engageable with the socket 111. Alternatively, the first coupling portion 11 may have protrusions (not shown in the drawings), and the second coupling portion 21 may have a socket corresponding to the protrusions (not shown in the drawings). By either way, the screw element 1 and the driving element can achieve both the force-driving and theft-protection functions. The alignment element 3 has a first sleeving section 31 and a second sleeving section 32, which are respectively engageable with the first coupling portion 11 and the second coupling portion 21. The first sleeving section 31 has a diameter greater than that of the first coupling portion 11 and exactly wraps the outer contour of the first coupling portion 11 so that the alignment element 3 and the first coupling portion 11 are concentric. The second sleeving section 32 has a diameter greater than that of the second coupling portion 21 and exactly wraps the outer contour of the second coupling portion 21. Thereby, the second coupling portion 21, the alignment element 3 and the first coupling portion 11 can be all positioned at an identical axis. When the alignment element 3 has been placed onto the first coupling portion 11, the second coupling portion 2 can be easily aligned to the axis of the first coupling portion 11 via the alignment element 3. Thus, the second coupling portion 2 can be conveniently engaged with the first coupling portion 11, as shown in FIG. 5 and FIG. 6.

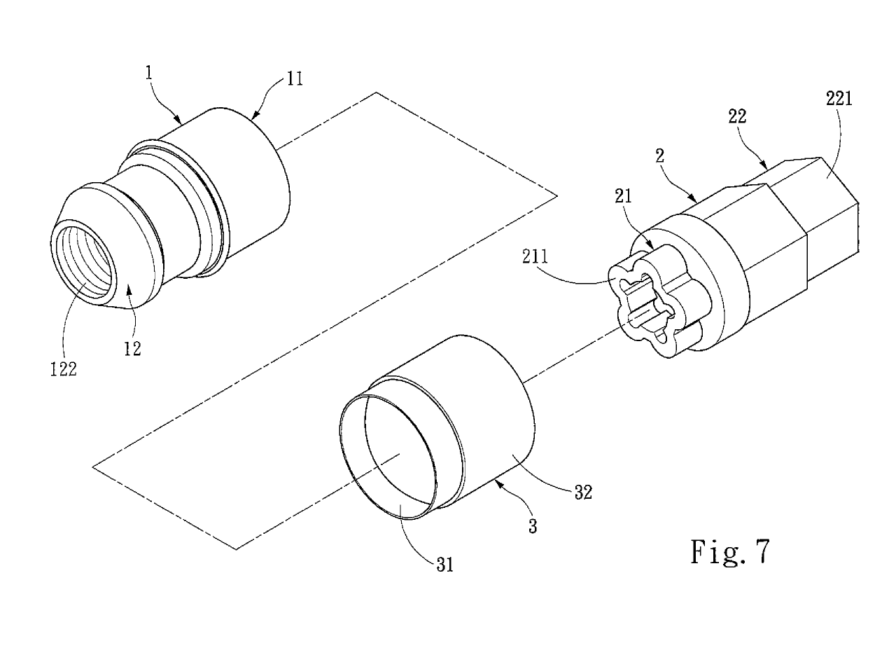

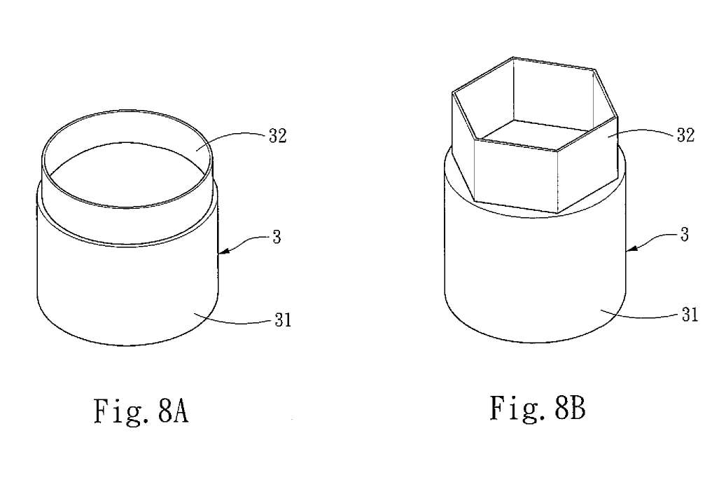

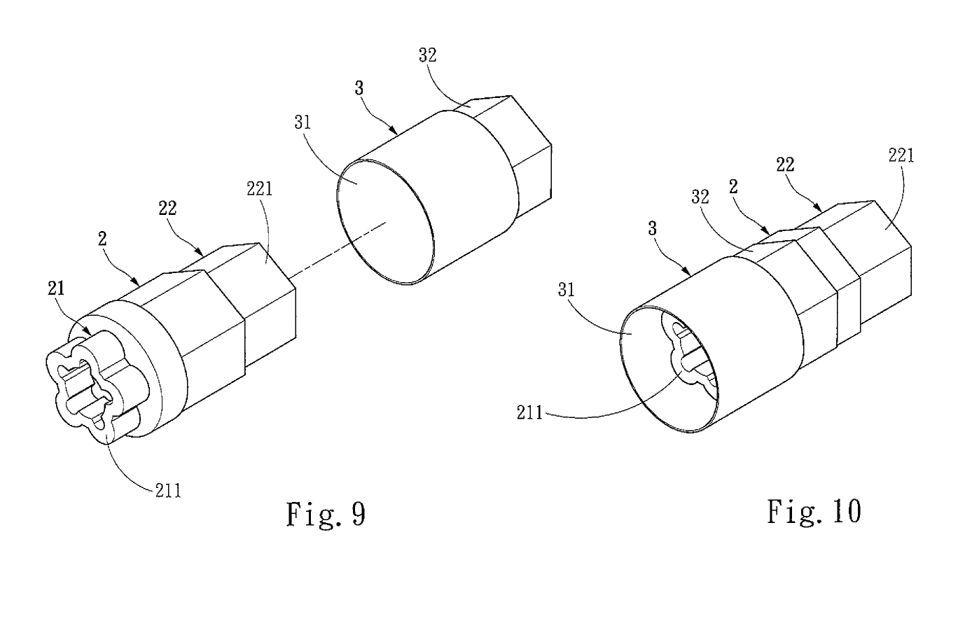

Refer to FIG. 7 for one embodiment having another type of screw element 1, wherein the screw element 1 has a screw end 12 having an inner thread 122, which makes the screw element 1 function as a nut. The alignment element 3 has a first sleeving section 31 and a second sleeving section 32, which respectively wrap the outer contours of the screw element 1 and the driving element 2. Thus, the driving element 2 and the screw element 1 can be aligned to an identical axis to convenience the engagement of the driving element 2 and the screw element 1. Refer to FIG. 8A and FIG. 8B. As the second sleeving section 32 of the alignment element 3 wraps the outer contour of the driving element 2, the shape of the second sleeving section 32 of the alignment element 3 may vary with the shape of the driving element 2. In FIG. 8A, the second sleeving section 32 has a circular shape. In FIG. 8B, the second sleeving section 32 has a hexagonal shape to meet the shape of another driving element 2. The shape of the alignment elements may be designed to have different insertion directions of the driving element 2, as shown in FIG. 9 and FIG. 10.

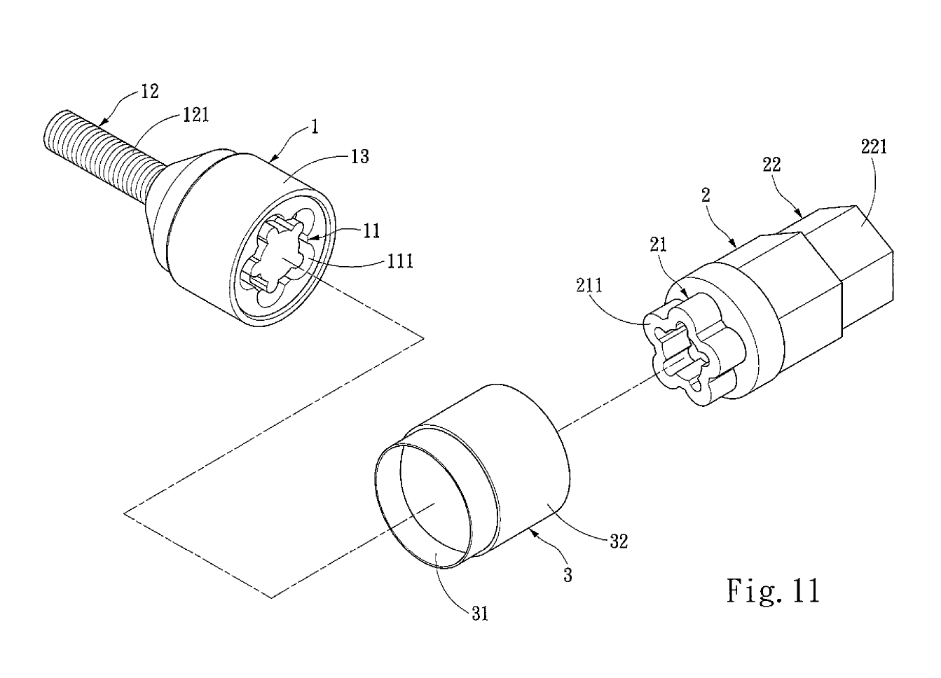

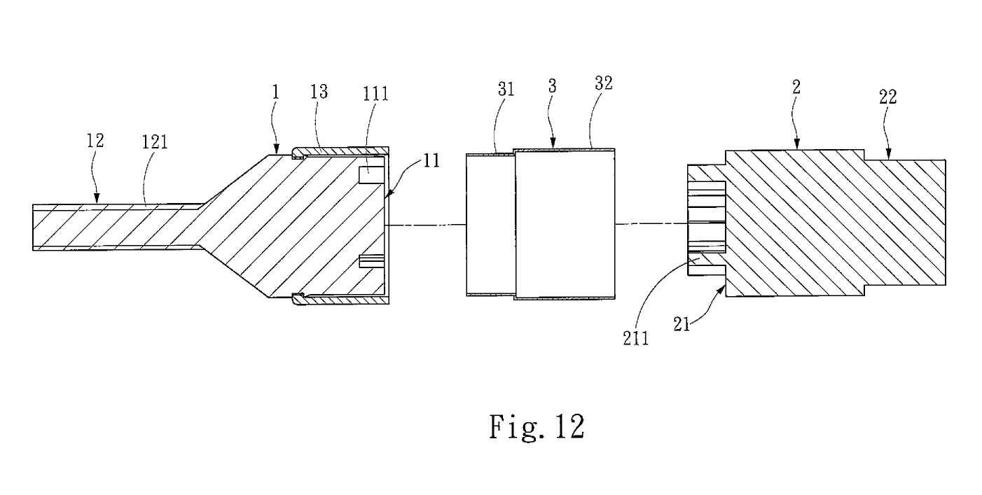

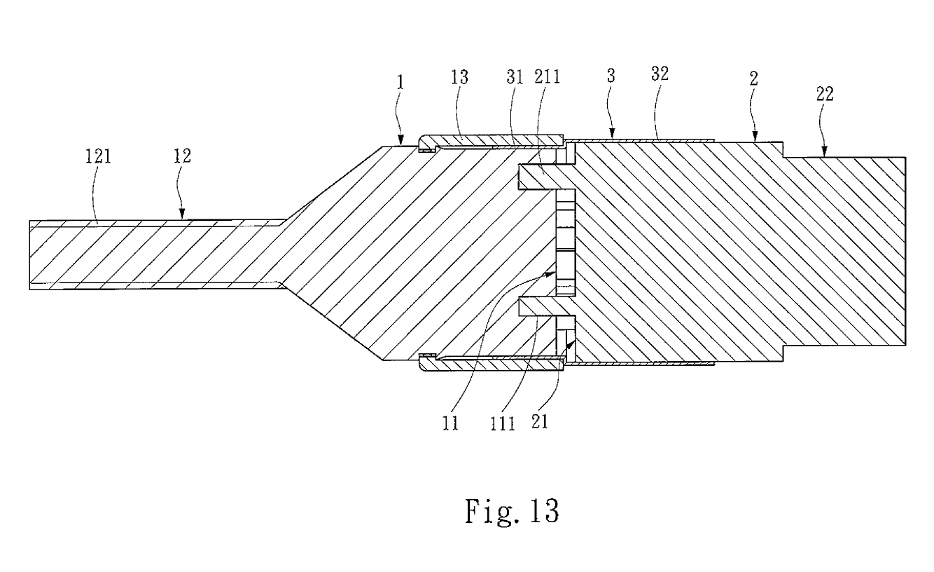

Further, the alignment element 3 is adapted to the “Theft-Protection Structure for Screw Kit” disclosed in the R.O.C. patent application No. 96208736 of the inventor of the present invention. Refer to FIG. 11, FIG. 12 and FIG. 13. Additionally, a protection ring 13 is installed in the perimeter of the first coupling portion 11 of the screw element 1, and a gap exists between the first coupling portion 11 and the protection ring 13. The first sleeving section 31 of the alignment element 3 may has a diameter allowing the first sleeving section 31 to be exactly inserted into the gap, and the first coupling portion 11 is thus fixed to the screw element 1. Then, the driving element 2 and the screw element 1 can be aligned to an identical axis via inserting the second coupling portion 21 into the second sleeving section 32. In the present invention, the diameter of the first sleeving section 31 may be smaller than, equal to, or greater than that of the second sleeving section 32. An appropriate alignment 3 may be chose to align the screw element 1 and the driving element 2 according to the dimensions of the screw element 1 and the driving element 2.

The embodiments described above are only to exemplify the present invention but not to limit the scope of the present invention. Any modification or variation according to the spirit of the present invention is to be also included within the scope of the present invention, which is based on the claims stated below.

The improvement of the screw kit of the present invention has been described above, and it is proved that the present invention possesses novelty and non-obviousness and meets the conditions for a patent. Thus, the Inventor files the patent application for the present invention. It is appreciated if the patent is approved fast.

What is claimed is:

1. A screw kit, which is a tool kit for fastening automobile components, comprising:
a screw element having a screw end and a first coupling portion;
a driving element having a driving end and a second coupling portion to couple with said first coupling portion; and
an alignment element having a first sleeving section and a second sleeving section respectively engageable with said first coupling portion and said second coupling portion.

2. The screw kit according to claim 1, wherein said first sleeving section has a diameter greater than that of said first coupling portion.

3. The screw kit according to claim 2, wherein said first sleeving section and said second sleeving section respectively have different diameters.

4. The screw kit according to claim 1, wherein said second sleeving section has a diameter greater than that of said second coupling portion.

5. The screw kit according to claim 1, wherein said screw end is a pillar structure having an outer thread, which makes said screw element function as a bolt.

6. The screw kit according to claim 5, wherein said first coupling portion and said second coupling portion respectively have a socket and a set of protrusions engageable with said socket.

7. The screw kit according to claim 1, wherein said screw end has an inner thread, which makes said screw element function as a nut.

8. The screw kit according to claim 7, wherein said first coupling portion and said second coupling portion respectively a socket and a set of protrusions engageable with said socket.

9. The screw kit according to claim 1, wherein said driving end is a geometrical structure having at least one driving facet.

10. The screw kit according to claim 1, wherein a protection ring is installed in the perimeter of said first coupling portion of said screw element.

11. The screw kit according to claim 10, wherein said first sleeving section of said alignment element can be inserted into a gap between said first coupling portion and said protection ring.
